(19) United States
(12) Patent Application Publication
(10) Pub. No.: US 2018/0006380 A1
(43) Pub. Date: Jan. 4, 2018

(54) ANTENNA ON SMART CARD AND INTERCONNECTION DEVICE

(71) Applicant: THOMSON LICENSING, Issy-les-moulineaux (FR)

(72) Inventors: Dominique LO HINE TONG, CESSON SEVIGNE (FR); Lionel BEAUREPAIRE, CESSON SEVIGNE (FR); Jean-Marc LE FOULGOC, Cesson Sevigne (FR)

(21) Appl. No.: 15/618,421

(22) Filed: Jun. 9, 2017

(30) Foreign Application Priority Data
Jun. 30, 2016 (EP) 16305823.3

(51) Int. Cl. H01Q 13/10; H01Q 1/22; H01Q 13/08

(52) U.S. Cl. CPC H01Q 13/106; H01Q 13/085; H01Q 1/2275; H01Q 1/2283

(57) ABSTRACT

An interconnection device is described including a transmission part for feeding an antenna, the transmission part including a signal feed element and a ground element connectable to a circuit board, a first end of the ground element connectable to the circuit board and a second end of the ground element connectable to the antenna and a first end of the signal feed element connectable to an antenna feeding port on the circuit board and a second end of the signal feed element connectable to an antenna feeding line of the antenna.

### CROSS-REFERENCE

This application claims the benefit, under 35 U.S.C. §119 of European Patent Application 16305823.3, filed Jun. 30, 2016.

### FIELD

The proposed apparatus is directed to an interconnection device for feeding an antenna for example an antenna provided on a smart card of a wireless communication device and fed through the circuit board (e.g., main printed circuit board (main PCB)) of the device.

### BACKGROUND

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Home-networking devices are becoming more and more important thanks to the various services than can be offered, in particular through the numerous embedded wireless systems, for example, data and video wireless link service thanks to the Wi-Fi systems, home-automation service using standards such as ZigBee, Zwave or 6LoWPAN, device remote control using for instance the Bluetooth or RF4CE protocol, and 3G/LTE based internet gateways. ZigBee is an IEEE 802.15.4-based specification for a suite of high-level communication protocols used to create personal area networks with small, low-power digital radios. Z-Wave is a wireless communications protocol for home automation. 6LoWPAN is an acronym for IPv6 over Low power Wireless Personal Area Networks. RF4CE is a ZigBee application profile.

All of these embedded wireless systems lead to the use of many antennas that have to be integrated inside the device casing with drastic constraints in terms of cost and performance (antenna efficiency, radiation pattern, isolation etc.) and more crucially in terms of space.

The most cost-effective conventional way to introduce an antenna is to print the antennas onto the circuit board of the home networking device. However, most of the board edges, where antennas must be placed to provide proper radiation, are already occupied: the front side is often occupied by numerous push-buttons and a display, the left side by a smart card holder and a hard disk drive (HDD) and, as usual, the rear side has many connectors (e.g., USB, HDMI, Ethernet, DC-in) and the RF (e.g., DTV, cable or satellite) tuner. These electronic components create obstacles to the radiation of radio waves and impair antenna performance Therefore, only the right side is free for on-board antenna integration, which is far from sufficient.

That being the case, the next option is to use off-board antennas, meaning antennas printed on a standalone board, then attached to the device casing and interconnected to the circuit board by means of a miniature coaxial cable. However, because of its high cost this solution is only deployed if no other option is possible.

### SUMMARY

The proposed apparatus relates to an interconnection device for an antenna in a wireless system for example a home-networking electronic device, such as a set-top-box (STBs), gateway and smart home device. It will be appreciated that the proposed apparatus is not limited to any specific type of device and may be applied to any wireless communication device. The proposed apparatus in some embodiments is applied to an antenna provided on a smart-card of a home-networking device and fed through the circuit board of the device.

The proposed apparatus in accordance with embodiments of the invention takes advantage of the presence of a smart card (SC) holder embedded in a home networking device to integrate onto it the antenna of a wireless system, the antenna being fed by using adequate design metal pins which are attached vertically onto the device circuit board where the wireless system circuit is implemented. These antenna pins can be either integrated in the plastic SC holder that supports already the SC pins or positioned freely under the SC but outside the central rectangular area where the SC chip and contact pads are placed.

According to a first aspect of the invention there is provided an interconnection device including a transmission part for feeding an antenna, the transmission part including a signal feed element and a ground element connectable to a circuit board, a first end of the ground element connectable to the circuit board and a second end of the ground element connectable to the antenna and a first end of the signal feed element connectable to an antenna feeding port on the circuit board and a second end of the signal feed element connectable to an antenna feeding line of the antenna.

In an embodiment the signal feed element and the ground element of the interconnection device are provided at the second end with flexible connector elements engageable with the antenna disposed on a smart card to feed the antenna and biased to hold said smart card in place. The ground element of the interconnection device includes an extension ground element folded away from the ground element such that the extension ground element extends over the signal feed element and the ground element to form a ground plane spaced apart from the signal feed element.

In another embodiment the signal feed element and the ground element extend parallel to each other.

In another embodiment the ground plane of the interconnection device is connectable to the circuit board via a plurality of grounding pins. The signal feed element of the interconnection device is connectable to the circuit board via at least one pin. The signal feed element of the interconnection device connectable to the antenna feeding line via at least one flexible pin.

In another embodiment the antenna disposed on said smart card is operational when the smart card is inserted into a smart card holder. The antenna is a tapered slot antenna.

In another embodiment the ground pins and the signal pin of the interconnection device connectable to the antenna are flexible so as to permit insertion of the smart card into the smart card holder and engage a pinout pad of the smart card and to also engage the antenna feeding line and at least one grounding pad of the antenna disposed on the smart card.

In another embodiment the signal feed element and the ground element of the interconnection device are arranged to form a micro-strip structure. The ground element and the signal feed element of the interconnection device are configured to provide mechanical rigidity and impedance matching from the circuit board to the antenna disposed on a smart card.

In another embodiment the interconnection device is configured to connect the antenna on the smart card to the antenna feeding port of the circuit board.

In another embodiment a device includes a circuit board, the circuit board having an antenna feeding port connectable to an interconnection device, the interconnection device being operational according to any of the above described embodiments.

In another embodiment a system includes a smart card holder for holding a smart card, the smart card having an antenna disposed thereon, an interconnection device and a circuit board, the circuit board having an antenna feeding port connectable to the interconnection device, the interconnection device configured to connect the antenna on the smart card to the antenna feeding port of the circuit board, the interconnection device operational according to any of the above described embodiments.

### BRIEF DESCRIPTION OF THE DRAWINGS

The proposed method and apparatus is best understood from the following detailed description when read in conjunction with the accompanying drawings. The drawings include the following figures briefly described below:

FIG. 1 depicts a typical architecture of a set top box, which is an example of a wireless communication device in which embodiments of the invention may be implemented.

FIG. 2 is an exemplary three dimensional view of a smart card (in a smart card holder) interconnected to the circuit board of a set top box, which is an example of a wireless communication device in which embodiments of the invention may be implemented.

FIG. 3 is an exemplary top view of a smart card (in a smart card holder) interconnected to the circuit board of a set top box, which is an example of a wireless communication device in which embodiments of the invention may be implemented.

FIG. 4 is an exemplary top view of an antenna embedded onto a smart card, the antenna being fed signals from a circuit board of a wireless communication device.

FIG. 5 is an exemplary top view of the antenna embedded onto the smart card.

FIG. 6 is an exemplary cross-sectional view of a smart card and the layers of the smart card in which the antenna is embedded.

FIG. 7 is an exemplary antenna feeding circuit printed on the circuit board of a wireless communication device.

FIG. 8 is an exemplary interconnection device in accordance with an embodiment of the invention for interconnecting the smart card antenna to the circuit board of a wireless communication device.

FIG. 9 is an interconnection device in accordance with an embodiment of the invention assembled onto the circuit board of a wireless communication device.

FIG. 10 is an exemplary depiction of the top pins of the interconnection device in accordance with an embodiment of the invention connected to the antenna embedded into the smart card.

FIG. 11 illustrates two exemplary views of the design device in accordance with an embodiment of the invention including the smart card having an antenna embedded thereon (in a smart card holder) and the interconnection device. The interconnection device connecting the smart card antenna to the circuit board of a wireless communication device. The left depiction is a perspective view and the right depiction is a top view.

FIG. 12 shows the return loss response of the exemplary smart card antenna.

FIG. 13 shows the peak gain response of the exemplary smart card antenna.

FIG. 14 shows the efficiency response of the exemplary smart card antenna.

FIG. 15 show the three dimensional radiation pattern of the exemplary smart card antenna at 2.45 GHz and 5.5 GHz.

FIG. 16 shows the proposed apparatus coping with a metal housing.

FIG. 17 is a block diagram of a home networking device such as a set top box.

It should be understood that the drawing(s) are for purposes of illustrating the concepts of the disclosure and is not necessarily the only possible configuration for illustrating the disclosure.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

A number of devices in accordance with embodiments of the invention will be described in what follows. One device relates to a smart card having disposed thereon an antenna. Another device relates to a smart card holder and a printed circuit board having an antenna feeding (input) port. The printed circuit board is configured to receive an interconnection device in accordance with an embodiment of the invention which interconnects the smart card (having the antenna) inserted into the smart card holder and the antenna feeding (input) port of the printed circuit card.

A smart card is a plastic card that embeds an integrated circuit, providing data storage, personal identification and authentication. It can be used for many purposes and applications, with the most usual being for serving as a credit card. In the particular use case of a wireless communication device, such as a set-top box (STB), the smart card is used as an access control for pay television and encrypted services. The ISO/IEC 7810 is an international standard that has defined several card sizes, with the most widespread being the format ID-1 specifying a size of 85.60×53.98 mm². All cards have a thickness of 0.76 mm

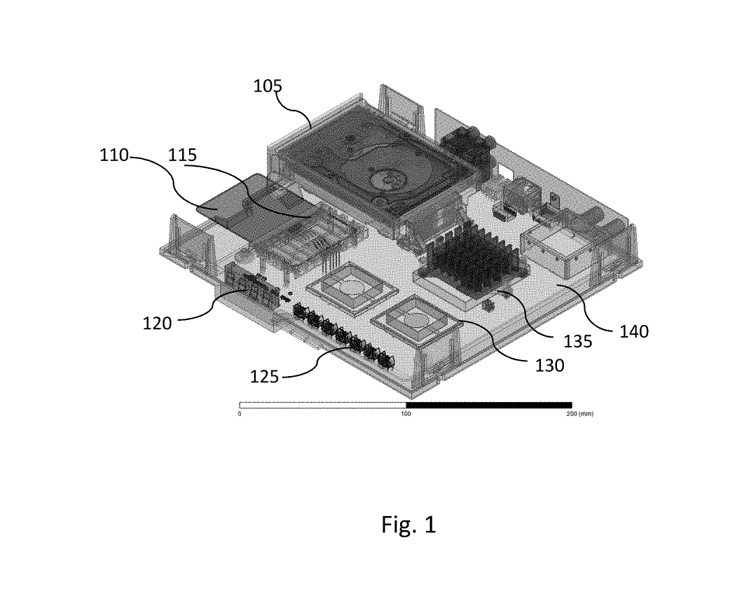

FIG. 1 shows the electro-mechanical architecture of a set-top box, which is an example of a wireless communication device in which embodiments of the invention may be implemented. The exemplary set-top box includes a hard disk drive 105, a smart card 110, a smart card holder and interconnection pins 115 connecting the smart card holder to a main circuit board 140 (e.g., main printed circuit board). On the front of the set top box there is a display 120 and a plurality of push buttons 125 to control the set top box. There is at least one wireless chipset 130 and a system on a chip 135.

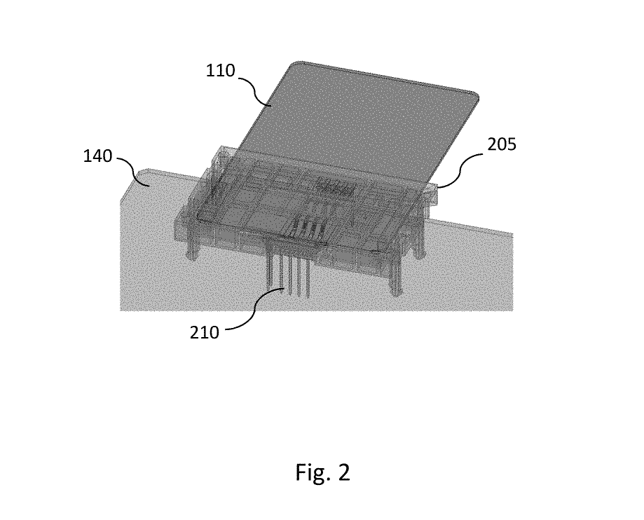

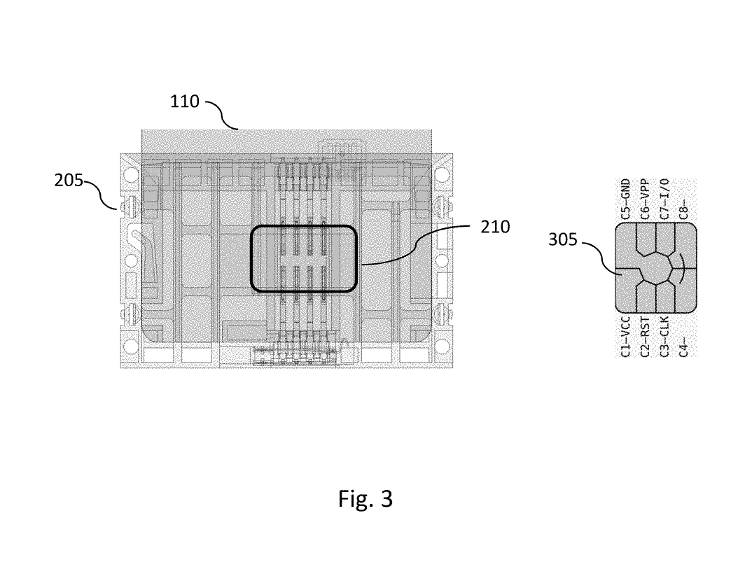

FIGS. 2 and 3 show how a smart card in accordance with an embodiment of the invention is interconnected to the circuit board of a wireless communication device such as the set top box of FIG. 1. FIG. 2 is an exemplary three dimensional view of a smart card (in a smart card holder) interconnected to the circuit board of a set top box. Smart card 110 and main circuit board 140 are the same as shown in FIG. 1. Smart card holder and interconnection pins 115 of FIG. 1 include smart card holder 205 and interconnection pins 210. The interconnection pins 210 connect the smart card holder to the main circuit board 140.

FIG. 3 is an exemplary top view of a smart card (in a smart card holder) interconnected to the circuit board of a set top box, which is an example of a wireless communication device. Smart card 110 is shown on FIGS. 1 and 2. Smart card holder 205 and interconnection pins 210 are shown on FIG. 2. The interconnection pins 210 are in contact with smart card die and pinout pad 305 shown to the right side and in outline on the main portion of FIG. 3.

A smart card is used as an access control by the network service providers (NSPs), providing the appropriate rights to access the services (e.g., TV channels) to which the end-user has subscribed. First, a plastic smart card holder is assembled onto the circuit board. This smart card holder includes four (4) vertical metal pins on each side that are inserted and soldered in the dedicated holes made on the circuit board. These vertical pins are then extended in the horizontal plane by using flexible metal pins, so that when a smart card is inserted into the smart card holder the pins are flexibly put in contact with the respective eight (8) pinout pads of the smart card.

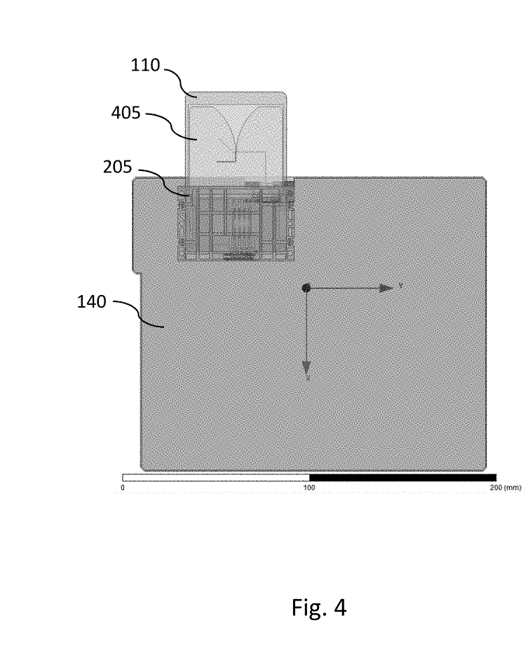

Embodiments of the proposed devices will now be described, by way of example, and with reference to the FIGS. 4-11.

FIG. 4 is an exemplary top view of an antenna 405 embedded onto a smart card 110, the antenna 405 being fed signals from a printed circuit board of a wireless communication device. FIG. 4 shows an overview of a smart card 110 inserted in its smart card holder 205 which is mounted onto a printed circuit board 140, and where on the bottom side of the smart card 110, a double-sided printed antenna is adhered. Smart card 110 is shown in FIGS. 1-3. Main circuit board is shown on FIGS. 1 and 2. Smart card holder is shown in FIGS. 2 and 3. Smart card includes an antenna adhered thereto.

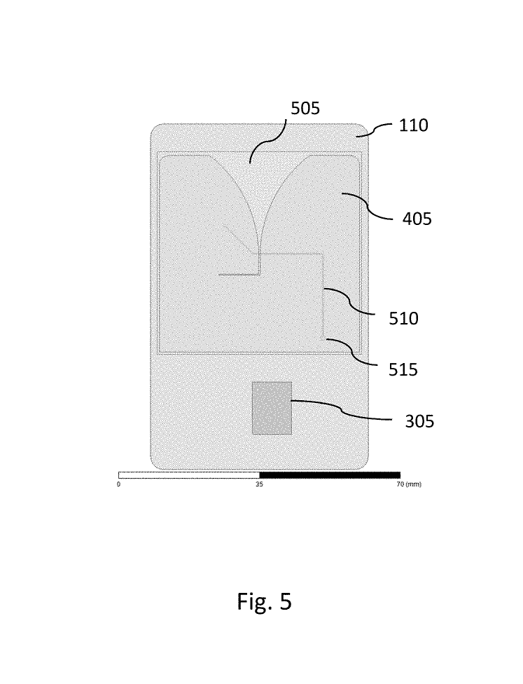

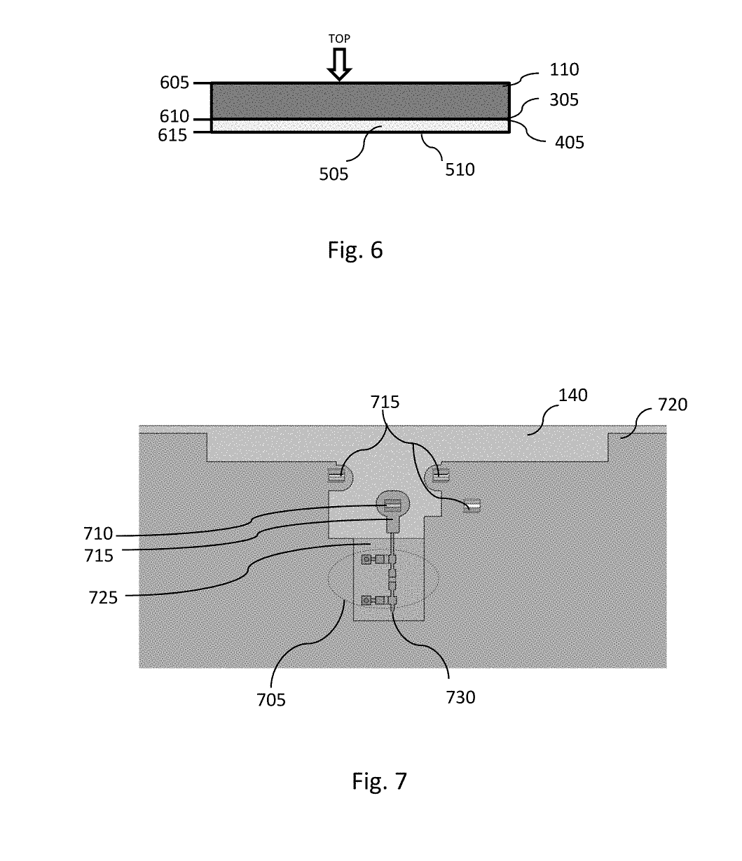

FIGS. 5 and 6 show in greater detail how the antenna is integrated onto the smart card. FIG. 5 is an exemplary top view of the antenna embedded onto the smart card. FIG. 6 is an exemplary cross-sectional view of a smart card and the layers of the smart card in which the antenna is embedded.

Smart card 110 of FIG. 5 is shown on FIGS. 1-4. Smart card die and pinout pad 305 is shown in FIG. 3. Antenna 405 is shown in FIG. 4. Antenna 405 shown in FIG. 5 is a tapered slot antenna which is embedded in the antenna substrate. Antenna input port 730 is on main circuit board 140 and provides input to the antenna 405. First a very thin antenna substrate 505 is used to embed the design, for instance, substrate such as flexible polyimide or Polyethylene terephthalate (PET) film with a typical thickness of 100 um. The antenna film, like a sticker, is then adhered (attached) to the bottom side of the smart card by using a double-side adhesive film. The above process results in a structure having three (3) metal layers (605, 610 and 615), where in 605 there is no metal conductor and 610 includes the smart card die and pinout pads 305. For this particular design, the radiating element 405 (antenna) is embedded in 610 while the antenna feeding line (element) 510 is printed in 615. Targeting dual-band Wi-Fi antennas that comply with the IEEE-802.11 a/b/g/n/ac standards, the radiating element selected here is a tapered slot antenna 405 fed by a micro-strip transmission line including antenna input port 515 on main circuit board.

One can notice here the large area available on the smart card for the integration of the radiating element—an area, which most of the time, is not available on the circuit board. It should be noted that more than one antenna can be embedded on the smart card, addressing, for instance, MIMO (multiple input multi output) applications. The above described approach offers additional advantages. For example, in comparison with a conventional solution, which uses an off-board fiberglass reinforced epoxy (FR4) based printed antenna with a coaxial cable for interconnection to the circuit board, the above described antenna-board is much more cost-effective with lower insertion loss and therefore better radiation efficiency. It can be noticed here the antenna feeding (input) port is placed intentionally outside of the smart card pinout pads longitudinal axis, since the goal is to avoid the antenna interconnecting metal pins rubbing the smart card pinout pads when the user inserts the smart card into the smart card holder. This will be shown and described further below.

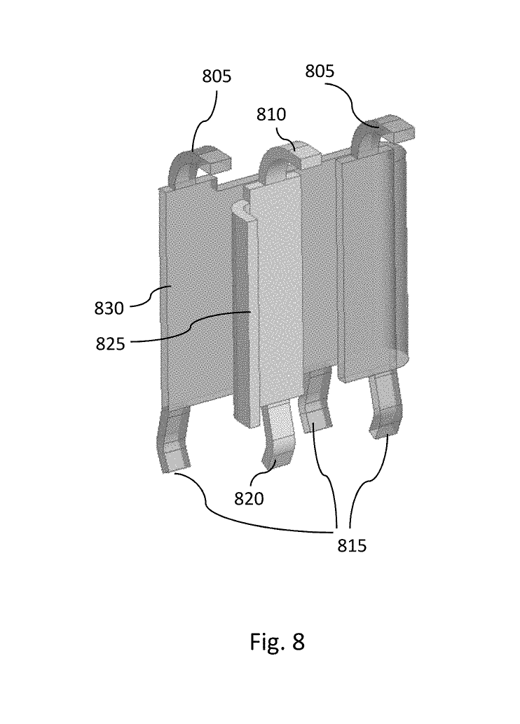

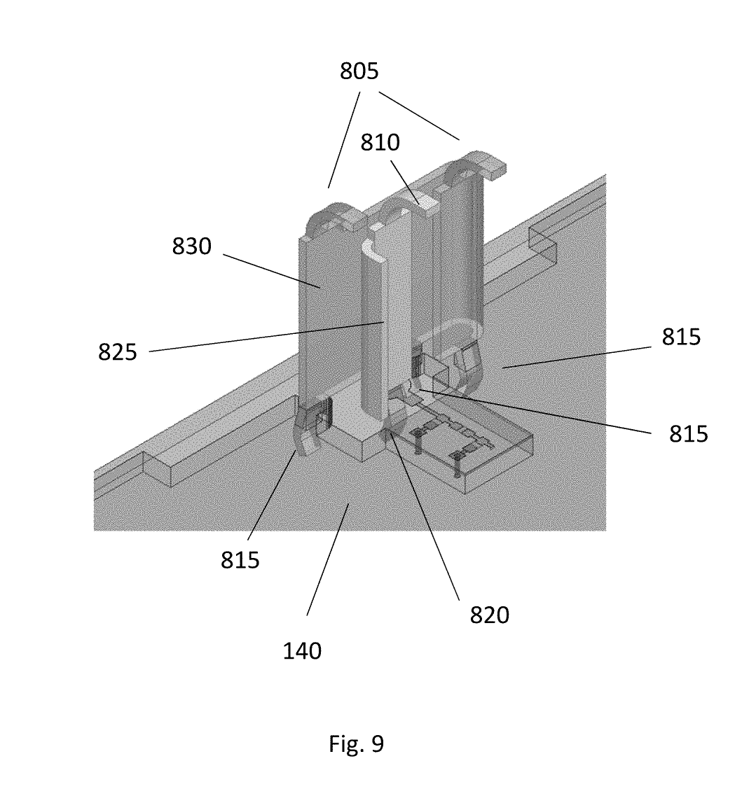

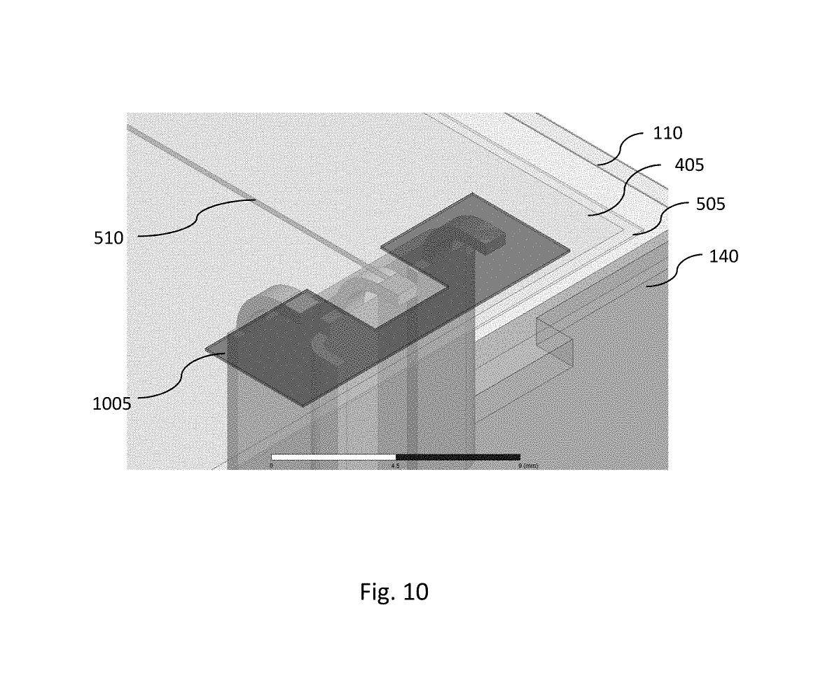

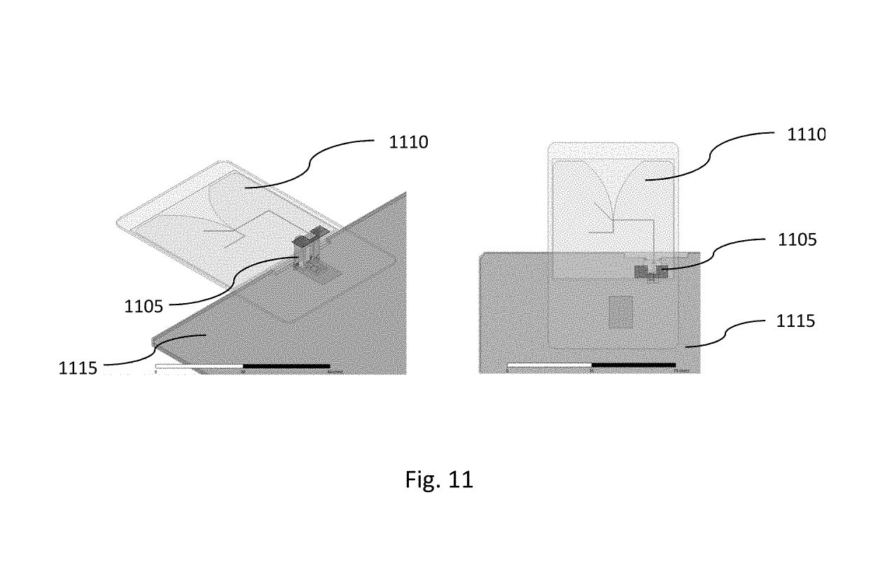

FIGS. 7-11 illustrate how the interconnection between the smart card and the circuit board is accomplished. FIG. 7 is an exemplary antenna feeding circuit printed on the circuit board of a wireless communication device. FIG. 8 is an exemplary interconnection device for interconnecting the smart card antenna to the circuit board of a wireless communication device. FIG. 9 is an exemplary interconnection device assembled onto the circuit board of a wireless communication device. FIG. 10 is an exemplary depiction of the top pins of the interconnection device connected to the antenna embedded into the smart card. FIG. 11 shows a perspective and top views of the whole design comprising the circuit board, the interconnecting metal parts and the smart card with the antenna adhered to the smart card.

FIG. 7 first shows the circuit design printed on the circuit board in accordance with an embodiment of the invention. The circuit board includes the antenna feeding (input) port 730, followed by a PI-type impedance matching circuit 705 and terminated by an open-circuit pad 710. The circuit board also includes four (4) holes 715 including a hole in the open-circuit pad 710. The hole in the open circuit pad serves to host the antenna feeding (vertical signal) pin and is located at the feeding (open circuit) pad and the three (3) other holes are drilled (bored) on the circuit board ground plane 720 and serve to transmit the grounding reference from the circuit board to the antenna substrate. The PI-type impedance matching circuit is disposed on in-layer ground plane 725.

FIG. 8 shows an interconnection device having two (2) separate vertical metal strips. The first metal strip 825 serves to transmit the signal from the circuit board to the antenna substrate and the second metal strip 830 serves to transmit the grounding reference. The first metal strip 825 and the second metal strip 830 being arranged to form a pseudo-micro-strip, the first metal strip being in a same vertical plane as the second metal strip. The second metal strip 830 is folded over by about 180 degrees around the first metal strip 825 such that the second metal strip 830 provides a metal plate behind the first metal strip 825. The second metal strip 830 thus forms a ground plane facing towards and spaced apart from the first metal strip 825. The first metal strip 825, thus, appears to be in the middle of the interconnection device serves to transmit the signal. The first metal strip (middle portion of the interconnection device) is shaped and dimensioned in a way to provide the adequate characteristic impedance and mechanical rigidity. Both the first metal strip 825 (signal strip) and the second metal strip 830 (grounding strip) are arranged (configured) properly in order to meet the required characteristic impedance and to form a pseudo-micro-strip structure.

The bottom side of the two metal strips includes four (4) pins that are dedicated to be plugged into respective hosting holes of the circuit board 140 as shown in FIG. 9. One pin on the bottom side of the two metal strips is the bottom signal pin 820, which is at the bottom end of the first metal (signal) strip 825. The remaining three pins on the bottom side of the interconnection device are bottom grounding pins 815, which are on the bottom end of the second metal strip 830. On the top side of the interconnection device, there are three (3) flexible pins: one connected to the signal strip 825 (first metal strip) and denoted as top signal pin 810, and the other two (2) pins 805 connected to the grounding (second metal) strip 830 (respectively on each of the two vertical planes). The primary requirement of the flexible pins is to be flexible enough to allow both the insertion of the smart card into the smart card holder and the contact with the smart card die and pinout pads and the antenna feeding element and grounding pads.

FIG. 10 shows a close-up view of how the three top flexible pins in accordance with an embodiment of the invention are put in contact with the antenna substrate 505 which is adhered to the smart card 110. The flexible pins make contact at the layer 615 of the multilayer structure, so that the signal pin excites directly the antenna feeding element 510 at the input port 515 (shown on FIG. 5), and the two grounding pins are connected to a grounding pad 1005 that surrounds partly the antenna feeding element 510. Then, in order to transmit the grounding reference to the inner layer 610 in which is printed the tapered slot antenna 405, the grounding pad is replicated in 610 and both pads interconnect with via-holes (not shown) in the antenna substrate 505. One of ordinary skill in the art would know that the distance between the different pins and the grounding pad design are critical parameters that allow matching perfectly the impedance from the circuit board input port to the smart card antenna feeding (input) port.

FIG. 11 illustrates two exemplary views of the design including the smart card having an antenna embedded 1110 thereon (in a smart card holder) and the interconnection device 1105. The interconnection device 1105 connecting the smart card antenna 1110 to the circuit board 1115 of a wireless communication device. The left depiction is a perspective view and the right depiction is a top view.

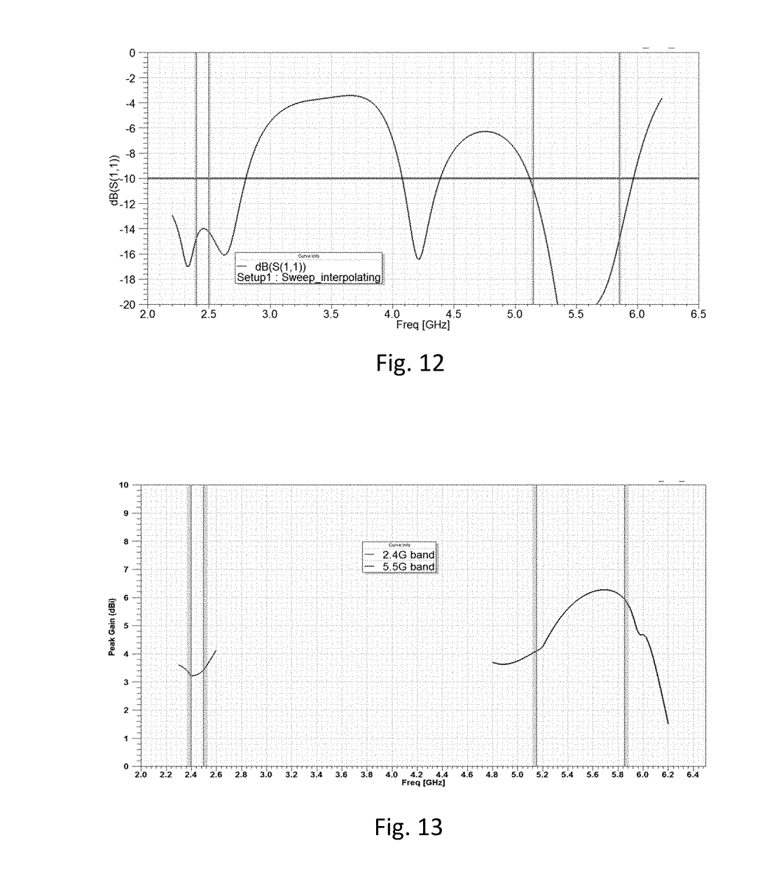

The design described in detail above has been fully simulated using the HFSS™ (High Frequency Structural Simulator) 3D electromagnetic tool, in order to demonstrate the high level of antenna performance that can be achieved with the proposed apparatus. FIGS. 12-15 highlight the simulation results.

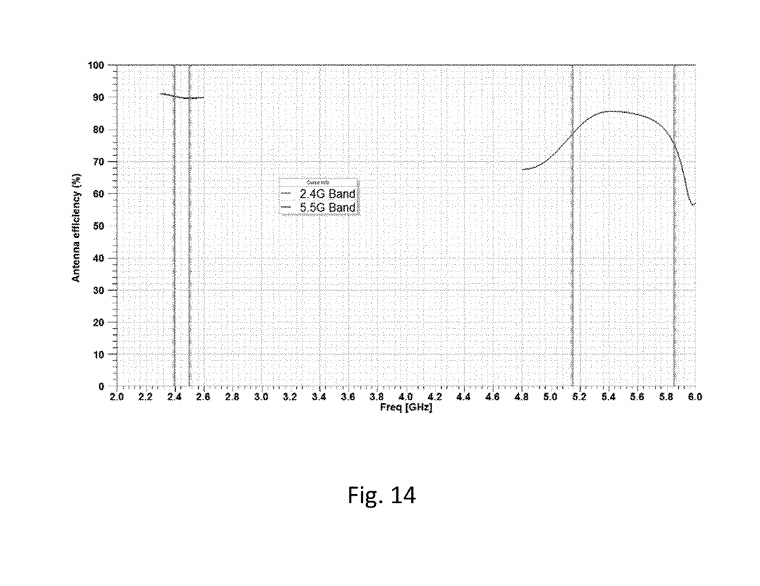

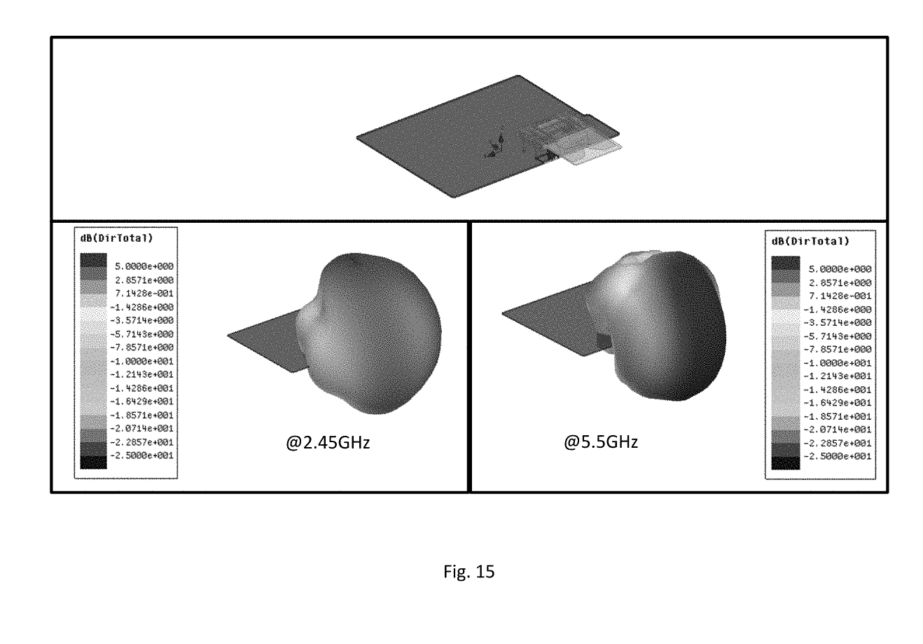

FIG. 12 shows the return loss response of the exemplary smart card antenna. As can be seen in FIG. 12, the antenna is well matched in the two Wi-Fi bands, with a return loss level lower than −14 dB in the 2.4 GHz band and lower than −10 dB in the 5.5 GHz band. FIG. 13 shows the peak gain response of the exemplary smart card antenna. As can be seen in FIG. 13, the peak gain is around 3-4 dBi and 4-6 dBi in the 2.4 GHz and 5.5 GHz bands, respectively. FIG. 14 shows the efficiency response of the exemplary smart card antenna. Importantly, FIG. 14 shows that the efficiency is better (higher, greater) than 80% in both bands, which is much higher than can be achieved by using an off-board printed circuit board antenna. FIG. 15 show the three dimensional radiation pattern of the exemplary smart card antenna at 2.45 GHz and 5.5 GHz. The three dimensional radiation pattern of the antenna is properly towards the front of the smart card.

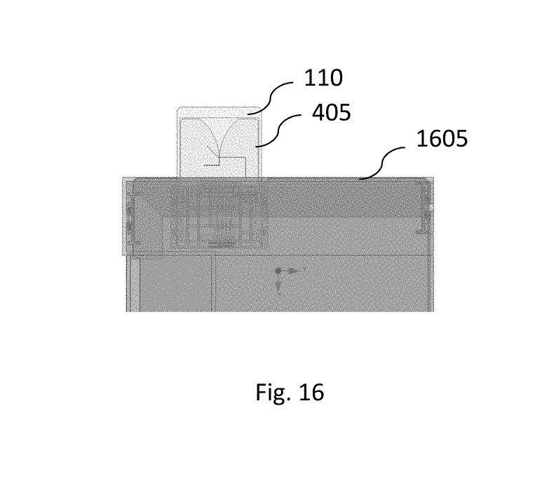

The proposed apparatus offers another not negligible advantage. Most of the time, once the smart card 110 is inserted inside the wireless communication device, a wide part remains outside the housing. Therefore, when the housing is metal 1605 based, with an antenna 405 remaining on the outside part of the smart card such as shown in FIG. 16, radiation outside the box is made possible. The proposed apparatus, thus, avoids thus using costly an external stick antenna.

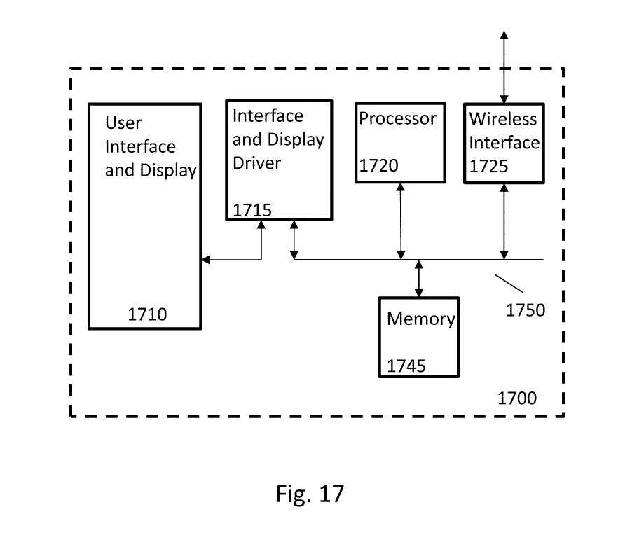

FIG. 17 is an example block diagram of the wireless communication device 1700 of FIG. 1. A wireless communication device is an electronic device such as, but not limited to, a set top box. The block diagram configuration includes a bus-oriented 1750 configuration interconnecting a processor 1720, and a memory 1745. The configuration of FIG. 17 also includes a wireless interface 1705.

Processor 1720 provides computation functions for the wireless communication device, such as the one depicted in FIG. 1. The processor 1720 can be any form of CPU or controller that utilizes communications between elements of the wireless communication device to control communication and computation processes. Those of skill in the art recognize that bus 1750 provides a communication path between the various elements of embodiment 1700 and that other point-to-point interconnection options (e.g. non-bus architecture) are also feasible.

User interface and display 1710 is driven by interface circuit 1715. The interface 1710 is used as a multimedia interface having both audio and video capability to display streamed or downloaded audio and/or video and/or multimedia content obtained via network interface 1725 and connection 1705 to a network.

Memory 1745 can act as a repository for memory related to any of the methods that incorporate the functionality of the media device. Memory 1745 can provide the repository for storage of information such as program memory, downloads, uploads, or scratchpad calculations as well as the storage of streamed or downloaded content including audio, video and multimedia content. Those of skill in the art will recognize that memory 1745 may be incorporated all or in part of processor 1720. Network interface 1725 has both receiver and transmitter elements for communication as known to those of skill in the art.

Network interface 1725 may include a wireless interface to communicate wirelessly to transmit requests for audio and/or video and/or multimedia content and receive the requested audio and/or video and/or multimedia content. In order to do so, a radio frequency interface may be provided. The radio frequency interface transmits and receives using an antenna, which may use a radio frequency wideband bandpass filter. The antenna may be disposed on a smart card, which is inserted into a smart card holder. The radio frequency interface may include any necessary software, hardware or firmware to control and communicate with the antenna on the smart card.

Other design of the vertical interconnecting parts can be used, for instance using three separate metal strips to form a ground-signal-ground coplanar structure. The interconnecting parts can be embedded into the smart card holder such as its metal pins. Instead of using an antenna printed on a thin film substrate attached to the smart card, the antenna design can be etched directly onto the smart card by using a plastic metallization process. The antenna can alternatively be excited by coupling (instead of direct contact) from the circuit board by using an adequate metal strip design. Also a 3D antenna instead of fully planar antenna as described above can be used.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus is programmed Given the teachings herein, one of ordinary skill in the related art will be able to contemplate these and similar implementations or configurations of the proposed method and apparatus.

For purposes of this application and the claims, using the exemplary phrase: “at least one of A. B and C,” the phrase means “only A, or only B, or only C, or any combination of A, B and C.”

1. An interconnection device, comprising:
a transmission part for feeding an antenna, said transmission part including a signal feed element and a ground element connectable to a circuit board;
a first end of said ground element connectable to said circuit board and a second end of said ground element connectable to said antenna; and
a first end of said signal feed element connectable to an antenna feeding port on said circuit board and a second end of said signal feed element connectable to an antenna feeding line of said antenna.

2. The interconnection device according to claim 1, wherein said signal feed element and said ground element are provided at the second end with flexible connector elements engageable with said antenna disposed on a smart card to feed said antenna and biased to hold said smart card in place.

3. The interconnection device according to claim 1, wherein said ground element includes an extension ground element folded away from said ground element such that said extension ground element extends over said signal feed element and said ground element to form a ground plane spaced apart from said signal feed element.

4. The interconnection device according to claim 1, wherein the signal feed element and the ground element extend parallel to each other.

5. The interconnection device according to claim 3, wherein said ground plane is connectable to said circuit board via a plurality of grounding pins.

6. The interconnection device according to claim 5, wherein said signal feed element is connectable to said circuit board via at least one signal pin.

7. The interconnection device according to claim 1, wherein said signal feed element is connectable to said antenna feeding line via at least one flexible pin.

8. The interconnection device according to claim 2, wherein said antenna disposed on said smart card is operational when said smart card is inserted into a smart card holder.

9. The interconnection device according to claim 1, wherein said antenna is a tapered slot antenna.

10. The interconnection device according to claim 6, wherein said grounding pins and said at least one signal pin connectable to said antenna are flexible so as to permit insertion of said smart card into said smart card holder and engage a pinout pad of said smart card and to also engage said antenna feeding line and at least one grounding pad of said antenna disposed on said smart card.

11. The interconnection device according to claim 2, wherein said signal feed element and said ground element are arranged to form a micro-strip structure.

12. The interconnection device according to claim 2, wherein said ground element and said signal feed element are configured to provide mechanical rigidity and impedance matching from said circuit board to said antenna disposed on said smart card.

13. The interconnection device according to claim 2, wherein said interconnection device is configured to connect said antenna on said smart card to said antenna feeding port of said circuit board.

14. A device comprising: a circuit board, said circuit board having an antenna feeding port connectable to an interconnection device, wherein said interconnection device comprises:
a transmission part for feeding an antenna, said transmission part including a signal feed element and a ground element connectable to a circuit board;
a first end of said ground element connectable to said circuit board and a second end of said ground element connectable to said antenna; and
a first end of said signal feed element connectable to an antenna feeding port on said circuit board and a second end of said signal feed element connectable to an antenna feeding line of said antenna.

15. The device according to claim 14, wherein said signal feed element and said ground element are provided at the second end with flexible connector elements engageable with said antenna disposed on a smart card to feed said antenna and biased to hold said smart card in place.

16. The device according to claim 14, wherein said ground element includes an extension ground element folded away from said ground element such that said extension ground element extends over said signal feed element and said ground element to form a ground plane spaced apart from said signal feed element.

17. The device according to claim 14, wherein the signal feed element and the ground element extend parallel to each other.

18. The device according to claim 16, wherein said ground plane is connectable to said circuit board via a plurality of grounding pins.

19. The device according to claim 18, wherein said signal feed element is connectable to said circuit board via at least one signal pin.

20. The device according to claim 14, wherein said signal feed element is connectable to said antenna feeding line via at least one flexible pin.

21. The device according to claim 15, wherein said antenna disposed on said smart card is operational when said smart card is inserted into a smart card holder.

22. The device according to claim 14, wherein said antenna is a tapered slot antenna.

23. The device according to claim 19, wherein said grounding pins and said at least one signal pin connectable to said antenna are flexible so as to permit insertion of said smart card into said smart card holder and engage a pinout pad of said smart card and to also engage said antenna feeding line and at least one grounding pad of said antenna disposed on said smart card.

24. The device according to claim 15, wherein said signal feed element and said ground element are arranged to form a micro-strip structure.

25. The device according to claim 15, wherein said ground element and said signal feed element are configured to provide mechanical rigidity and impedance matching from said circuit board to said antenna disposed on said smart card.

26. The device according to claim 15, wherein said interconnection device is configured to connect said antenna on said smart card to said antenna feeding port of said circuit board.

27. A system comprising:
a smart card holder for holding a smart card, said smart card having an antenna disposed thereon;
an interconnection device; and
a circuit board said circuit board having an antenna feeding port connectable to said interconnection device, said interconnection device is configured to connect said antenna on said smart card to said antenna feeding port of said circuit board.

28. The system according to claim 27, wherein said interconnection device further comprises:
a transmission part for feeding an antenna, said transmission part including a signal feed element and a ground element connectable to a circuit board;
a first end of said ground element connectable to said circuit board and a second end of said ground element connectable to said antenna; and
a first end of said signal feed element connectable to an antenna feeding port on said circuit board and a second end of said signal feed element connectable to an antenna feeding line of said antenna.
